(19) United States
(12) Patent Application Publication
(10) Pub. No.: US 2005/0160871 A1
(43) Pub. Date: Jul. 28, 2005

(54) Two position spring biased lever system

(76) Inventors: Douglas Dombrowski, Troy, MI (US); Artur Ostrowski, Rochester Hills, MI (US); Howard W. Kuhlman, Rochester Hills, MI (US)

Correspondence Address: DELPHI TECHNOLOGIES, INC., M/C 480-410-202, PO BOX 5052, TROY, MI, 48007, US

(21) Appl. No.: 10/766,391

(22) Filed: Jan. 28, 2004

(51) Int. Cl. G05G 1/04

(52) U.S. Cl. 74/532

(57) ABSTRACT

A two position spring biased lever system has a lever that pivots on a support between a first position and a second position, and a torsion spring. The torsion spring has a spring arm that is attached to a central coil at one end and that has an opposite distal end that is engaged in a notch of the lever. The torsion spring is stressed so that the spring arm biases the lever toward the second position while holding the lever in the first position when the distal end is in the notch. The spring arm moves the lever to the second position when the distal end is disengaged from the notch.

### TECHNICAL FIELD

This invention relates to a spring biased lever system in which a lever is held in one or the other of two possible end-of-stroke positions.

### BACKGROUND OF THE INVENTION

A two position, spring biased lever system where the lever is required to be spring biased into one or the other of two possible end positions commonly use an over center spring. The over center spring locates the lever in one or the other end-of-stroke-positions but resists any positioning of the lever between the two end positions. In such a system, the lever moves from one end position to the other end position through a neutral center position where the lever is not spring biased toward either end position. The stroke or movement of the lever from one end position to the other end position is actuated by an initial movement of the lever to the neutral center position. This initial movement is usually a relatively long part of the stroke that is against the bias of the spring. After passing the neutral center position, the torque on the lever is reversed and the remaining part of the stroke to the other end position is assisted by the spring. The neutral center position is unstable so that as a practical matter, actuation requires an initial movement of the lever to a position that is slightly past the neutral center position.

Known systems of the above type are typically symmetrical so that the return stroke to the first end position is substantially the same, that is, actuation requires an initial movement of the lever that is a relatively long part of the stroke that is against the bias of the spring.

Symmetrical over center systems are well known and used satisfactorily in many applications. However, in some applications, it is desired to minimize or at least reduce substantially the actuation requirements of the lever system in at least one direction.

### SUMMARY OF THE INVENTION

The invention provides a two position, spring biased lever system which requires only a small initial movement of the lever from one end of the two end-of-stroke positions before the spring assists the remaining part of the stroke to the other end position. Thus the system of the invention at least substantially reduces the actuation requirements of the system in at least one direction.

In a preferred embodiment, the spring has a spring arm that has a distal end that engages a notch in the lever to hold the lever in a first end-of-stroke position. The spring is stressed so that the spring arm biases the lever to the second, opposite end-of-stroke position while holding the lever in the first position. Very little movement is required to release the distal end of the spring arm from the notch so that the lever is moved to the second position by the spring.

### BRIEF DESCRIPTION OF THE DRAWINGS

FIG. 1 is a schematic drawing of a typical prior art two position spring biased lever system;

FIG. 2 is a schematic drawing of a two position spring biased lever system of a preferred embodiment of the invention showing the lever in a first end-of-stroke position;

FIG. 3 is an enlargement of the circled portion shown in FIG. 2;

FIG. 4 is a schematic drawing of the two position spring biased lever system of the preferred embodiment of the invention showing the lever in the second, opposite end-of-stroke position; and

FIG. 5 is a perspective view of the spring that is shown in the preferred embodiment of FIGS. 2, 3 and 4.

### DETAILED DESCRIPTION OF PREFERRED EMBODIMENT

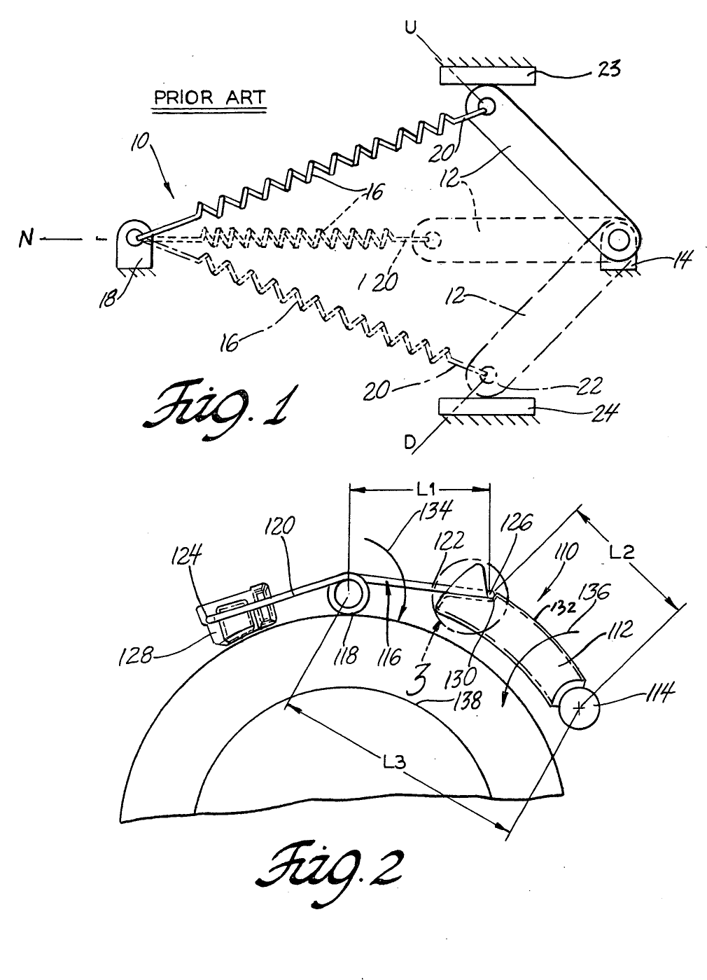

Referring now to FIG. 1, the typical prior art two position spring biased lever system 10 comprises a lever 12 that pivots on a support 14 at one end and an over center spring 16. In this particular example, the over center spring 16 is a coil compression spring that has one end pivotally mounted on a support 18 at an end that is remote from lever 12. The distal end 20 of the spring 16 is pivotally mounted on the distal end 22 of the lever 12; the distal end 22 of lever 12 being at the opposite end of the pivot end of lever 12.

Lever 12 is spring biased into one or the other of two possible end-of-stroke positions by over center spring 16 which resists any positioning of lever 12 between the two end positions. In the example of FIG. 1, the end positions are illustrated as an up position where lever 12 engages an up stop 23 and a down position where lever 12 engages a down stop 24. In the example of FIG. 1, lever 12 is shown in solid line in the up position where lever 12 engages up stop 23. In system 10, lever 12 is moved from one end position, the up position labeled U in FIG. 1, to the other end position, the down position labeled D in FIG. 1, through a neutral center position labeled N in FIG. 1. In the neutral position coil spring 16 is compressed to a maximum extent storing considerable energy. However, lever 12 and spring 16 are aligned longitudinally. Consequently spring 16 does not produce any moment on lever 12 so that lever 12 is not spring biased toward either end position.

The initial movement of lever 12 from the first or up position U to the neutral center position N required for actuating movement to the down position D, is a relatively long stroke against the bias of the spring 16 which expands and applies a counterclockwise torque to lever 12. After passing the neutral center position N, lever 12 is “over center” so that the remaining stroke to the second or down position D is assisted by spring 16. System 10 is symmetrical so that the return stroke to the first end or up position U is substantially the same, that is actuation requires an initial substantial stroke against the bias of spring 16.

Referring now to FIGS. 2, 3, 4 and 5 the two position, spring biased lever system 110 of the invention comprises a lever 112 that pivots on a support 114 at one end and a spring 116. In this particular example the spring 116 is a torsion spring comprising a central coil 118 with tangential spring arms 120 and 122 connected to the respective ends of the central coil 118 as best shown in FIG. 5. The distal ends 124 and 126 of the respective spring arms 120 and 122 are bent at a right angle. The distal end 124 of spring arm 120 is anchored in support 128 as best shown in FIGS. 2 and 4. The distal end 126 of spring arm 122 is retained in a notch 130 in the outer surface of lever 112 that is near the distal end 132 of lever 112, the distal end 132 of lever 112 being at the opposite end of lever 112 from the pivot end of lever 112 as best shown in FIGS. 2, 3 and 4.

When assembled into the spring biased lever system 110, torsion spring 116 is stressed so that tangential spring arm 122 is always biased by coil 118 in a clockwise direction against the outer surface of lever 112 as indicated by arrow 134 in FIGS. 2 and 4. This being the case, lever 112 in turn, is always spring biased in the counterclockwise direction as indicated the arrow 136 in FIGS. 2 and 4.

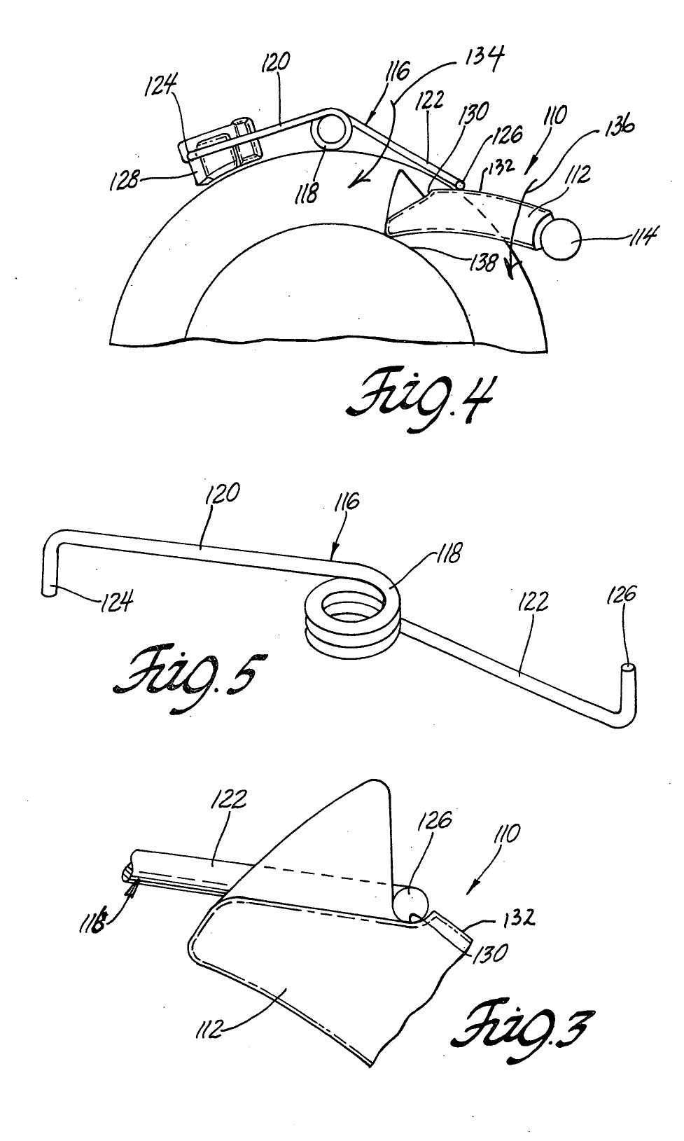

Lever 112 has two possible end-of-stroke, positions. One end position, which is an up position is shown in FIGS. 2 and 3, and the other position is a down position which is shown in FIG. 4. Lever 112 is held in the first end or up position shown in FIGS. 2 and 3 by the notch 130 of lever 112 even though the clockwise moment of spring arm 122 produces a counterclockwise moment on lever 112 as indicated by arrow 136. Notch 130 does not permit either clockwise movement of spring arm 126 or counterclockwise movement of lever 112 because the spring arm 122 and the lever 112 effectively hold each other in the first or up position due to geometrical interference. The length L-1 of spring arm 126 from its pivot to distal end 126 when added to the length L-2 of lever 112 from notch 130 to its pivot exceeds the length L-3 from pivot to pivot and hence neither can pivot inwardly.

The second or down position of lever 112 is shown in FIG. 4. In the system 110 of the invention, lever 112 is moved from one end position, the up position of FIG. 2, to the other end position, the down position of FIG. 4, by a small initial movement of lever 112 in the counterclockwise direction, to snap distal end 126 of spring arm 122 out of notch 130. Once distal end 126 is out of notch 130, spring arm 122 and lever 112 are both free to pivot clockwise because distal end 126 slides along outer surface 132 of lever 112 reducing the effective length of lever 112 and eliminating the geometrical interference. Thus spring arm 122 biases lever 112 counterclockwise to the second or down position shown in FIG. 4 where lever 112 engages down stop 138.

While very little initial stroke is necessary to actuate movement of lever 112 from the up to the down position, the opposite is not true. The entire movement or stroke back to the up position must be provided against the bias of spring 116 until distal end 126 of spring arm 122 engages in notch 130.

While a particular type of torsion spring has been illustrated and described in connection with the preferred embodiment, other types of torsion springs or springs may be used. For instance, a torsion spring anchored at one end of the coil having a single tangential spring arm that has a distal end engaging the notch of the lever or a cantilevered leaf spring having a distal end engaging the notch of the lever may be used. In other words, it will be readily understood by those persons skilled in the art that the present invention is susceptible of broad utility and application. Many embodiments and adaptations of the present invention other than those described above, as well as many variations, modifications and equivalent arrangements, will be apparent from or reasonably suggested by the present invention and the foregoing description, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the following claims and the equivalents thereof.

1. A two position, spring biased lever system comprising:
a lever that pivots on a support between a first position and a second position, and
a spring having an arm that biases the lever toward the second position, the arm engaging the lever to hold the lever in the first position.

2. A two position, spring biased lever system comprising:
a lever that pivots on a support between a first position and a second position, and
a spring having a spring arm that engages a notch in the lever to hold the lever in the first position while biasing the lever toward the second position when the lever is in the first position.

3. A two position spring biased lever system comprising:
a lever that pivots on a support between a first position and a second position, and
a torsion spring having a tangential spring arm that is attached to a central coil at one end and that has a distal end that is engaged in a notch of the lever,
the torsion spring being stressed so that the spring arm holds the lever in the first position when the distal end is in the notch while biasing the lever toward the second position,
the spring arm moving the lever to the second position when the distal end is disengaged from the notch.

4. The two position, spring biased lever system as defined in claim 3 wherein the distal end of the spring arm when released from the notch slides along a surface of the lever to bias the lever to the second position.

5. The two position spring biased lever system as defined in claim 3 wherein the distal end of the spring arm is a substantially perpendicular end portion of the spring arm, which when released from the notch slides along a surface of the lever to bias the lever to the second position.

6. The two position spring biased lever system as defined in claim 3 wherein the spring arm has a length L-1 measured from its pivot to the distal end, wherein the lever has a length L-2 measured from its pivot to the notch, and wherein the system has a length L-3 measured from the pivot of the spring arm to the pivot of the lever and wherein the sum of the length L-1 and the length L-2 exceeds the length L-3 when the lever is in the first position.

7. The two position spring biased lever system as defined in claim 5 wherein the spring arm has a length L-1 measured from its pivot to the distal end, wherein the lever has a length L-2 measured from its pivot to the notch, and wherein the system has a length L-3 measured from the pivot of the spring arm to the pivot of the lever and wherein the sum of the length L-1 and the length L-2 exceeds the length L-3 when the lever is in the first position.
